(19) United States
(12) Patent Application Publication
(10) Pub. No.: US 2019/0088932 A1
(43) Pub. Date: Mar. 21, 2019

(54) ELECTRODE, BATTERY CELL AND BATTERY CELL ARRANGEMENT

(71) Applicants: Nanyang Technological University, Singapore (SG); The Maritime and Port Authority of Singapore, Singapore (SG)

(72) Inventors: Rachid Yazami, Singapore (SG); Wenyu Zhang, Singapore (SG)

(21) Appl. No.: 15/738,819

(22) PCT Filed: Jun. 23, 2016
(86) PCT No.: PCT/SG2016/050285

§ 371 Date: Dec. 21, 2017

(30) Foreign Application Priority Data
Jun. 23, 2015 (SG) 10201504968R

(51) Int. Cl. H01M 4/36; H01M 4/38; H01M 4/62; H01M 4/04; H01M 10/052; H01M 4/134; H01M 4/1395

(52) U.S. Cl. CPC H01M 4/364; H01M 4/386; H01M 4/387; H01M 4/625; H01M 4/1395; H01M 4/0404; H01M 10/052; H01M 4/134; H01M 4/622

(57) ABSTRACT

According to embodiments of the present invention, an electrode is provided. The electrode includes silicon, tin, and a non-alloy of a transition metal. According to further embodiments of the present invention, a battery cell including the electrode and a battery arrangement having a plurality of battery cells are also provided. Methods of forming the electrode, the battery cell and the battery arrangement are also provided.

### CROSS-REFERENCE TO RELATED APPLICATION

This application claims the benefit of priority of Singapore patent application No. 10201504968R, filed 23 Jun. 2015, the content of it being hereby incorporated by reference in its entirety for all purposes.

### TECHNICAL FIELD

Various embodiments relate to an electrode, a battery cell, a battery arrangement, a method of forming an electrode, a method of forming a battery cell and a method of forming a battery arrangement.

### BACKGROUND

Lithium-ion (Li-ion) batteries have been widely used and investigated for portable personal electronic devices and electric vehicles. At present, carbon-based materials are the most popular anode materials for Li-ion batteries with a storage capacity of about 370 mAh/g. However, it is necessary to develop new anode materials with large specific capacities.

Silicon (Si) is one of the most attractive candidates due to its ultra-high specific capacities (˜4200 mAh/g). However, Si suffers from poor cyclability and low 1st-cycle Coulombic efficiency.

### SUMMARY

According to an embodiment, an electrode is provided. The electrode may include silicon, tin, and a non-alloy of a transition metal.

According to an embodiment, a battery cell is provided. The battery cell may include a first electrode as described herein, a second electrode, and an electrolyte electrically coupled to the first electrode and the second electrode.

According to an embodiment, a battery arrangement is provided. The battery arrangement may include a plurality of battery cells, each battery cell of the plurality of battery cells is as described herein.

According to an embodiment, a method of forming an electrode is provided. The method may include providing a starting material including a precursor material of silicon, a precursor material of tin and a precursor material of a transition metal, and processing the starting material to form an electrode including the silicon, the tin, and a non-alloy of the transition metal.

According to an embodiment, a method of forming a battery cell is provided. The method may include forming a first electrode as described herein, providing a second electrode, and providing an electrolyte electrically coupled to the first electrode and the second electrode.

According to an embodiment, a method of forming a battery arrangement is provided. The method may include forming a plurality of battery cells, wherein each battery cell of the plurality of battery cells is formed as described herein.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic cross-sectional view of an electrode, according to various embodiments.

FIG. 1B shows a schematic cross-sectional view of a battery cell, according to various embodiments.

FIG. 1C shows a schematic cross-sectional view of a battery arrangement, according to various embodiments.

FIG. 1D shows a flow chart illustrating a method of forming an electrode, according to various embodiments.

FIG. 1E shows a flow chart illustrating a method of forming a battery cell, according to various embodiments.

FIG. 1F shows a flow chart illustrating a method of forming a battery arrangement, according to various embodiments.

FIG. 2 shows a plot of X-ray diffraction (XRD) patterns for Samples A and B as described in Table 1.

FIGS. 3(a) and 3(b) show scanning electron microscopy (SEM) images of as-prepared Samples A and B. The scale bars represent 1 μm.

FIGS. 3(c) and 3(d) show energy dispersive X-ray (EDX) results for Samples A and B.

FIGS. 4A to 4C show the lithium (Li) half-cell performance of silicon-iron-tin-carbon (Si—Fe—Sn—C) material, according to various embodiments.

FIGS. 5A to 5C show the battery performance of the comparative silicon-carbon (Si—C) material.

FIGS. 6A and 6B show results of the cycle profiles of a pouch cell with double-coated lithium iron manganese phosphate (LFMP) and silicon-tin-iron (Si—Sn—Fe) electrodes, according to various embodiments.

FIGS. 7A to 7C show results for the pouch cell with double-coated lithium iron manganese phosphate (LFMP) and silicon-tin-iron (Si—Sn—Fe) electrodes, according to various embodiments.

FIGS. 8A and 8B show results of the cycle profiles of a pouch cell with double-coated lithium cobalt oxide (LCO) and silicon-tin-iron (Si—Sn—Fe) electrodes, according to various embodiments.

FIGS. 9A and 9B show results for the pouch cell with double-coated lithium cobalt oxide (LCO) and silicon-tin-iron (Si—Sn—Fe) electrodes, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

Various embodiments may provide electrode (e.g., anode) materials for battery (e.g., lithium-ion (Li-ion) battery) application.

Various embodiments may provide silicon-tin-M (Si—Sn-M) based electrode (e.g., anode) materials for batteries (e.g., Li-ion batteries), where “M” may be a transition metal (element), including but not limited to iron (Fe), manganese (Mn), nickel (Ni), cobalt (Co), vanadium (V). It should be appreciated that other transition metals may be used as the material for “M”. Further, it should be appreciated that “M” may include at least one transition metal (element), or in other words, “M” may include one or more transition metals. For example, various embodiments may provide Si—Sn-M1- . . . -Mn based electrode materials, where n=2, 3, or any higher number, and each “M” may include a different transition metal (element).

In various embodiments, the Si—Sn-M based materials may be synthesized by a simple one-step mechanical ball milling process.

In various embodiments, as will be described further below, for example, when M=Fe, X-ray diffraction (XRD) pattern confirms the presence of crystalline Si, Sn and Fe. No XRD evidence of alloy formation between Si, Sn and Fe components is found, a major characteristics of the materials of various embodiments.

The Si—Sn-M based electrode materials of various embodiments may exhibit high 1st-cycle Coulombic efficiency of >90% and a much improved cycling stability.

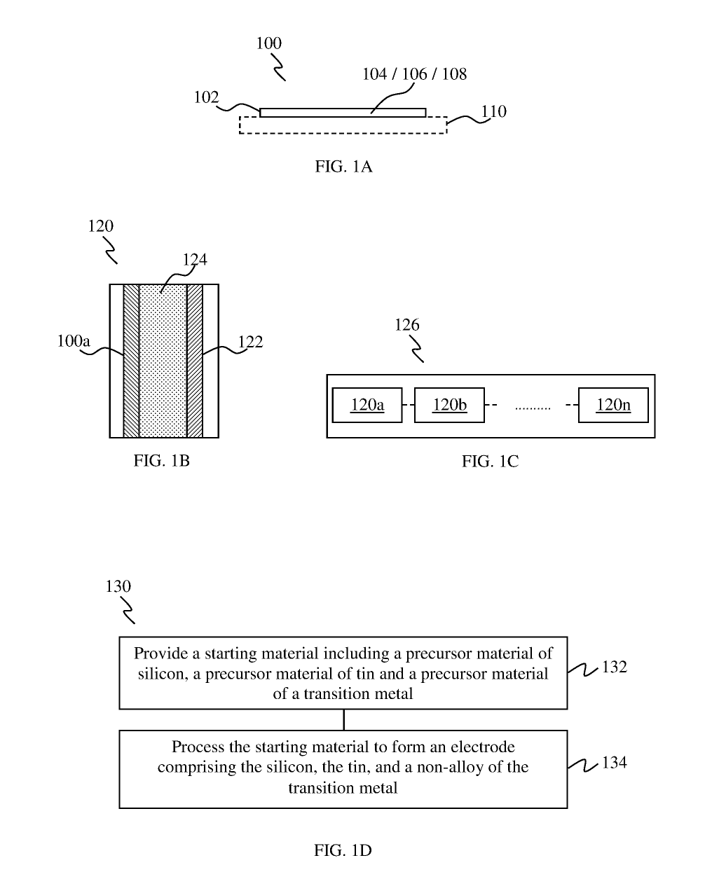

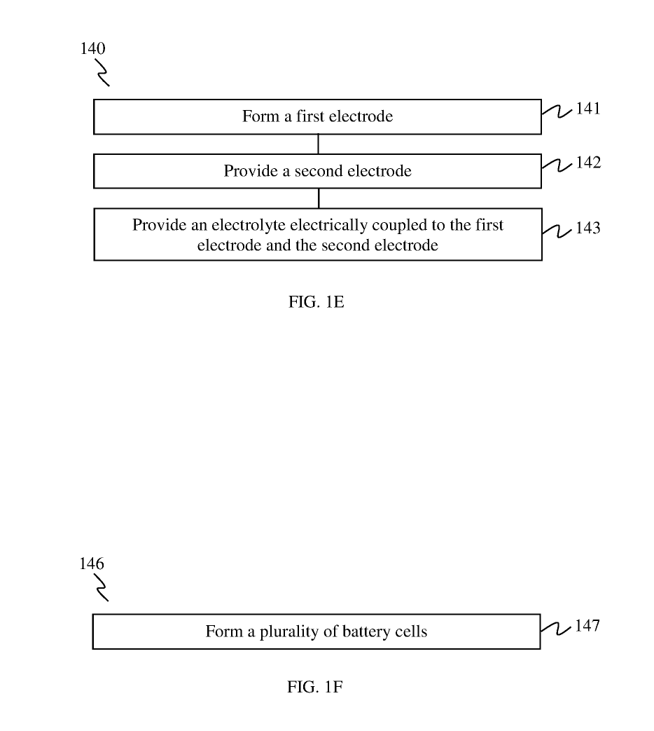

FIG. 1A shows a schematic cross-sectional view of an electrode 100, according to various embodiments. The electrode 100 may include silicon 104, tin 106, and a non-alloy of a transition metal 108.

In other words, an electrode 100 may be provided. The electrode 100 may have a composition or may be made of silicon (Si) 104, tin (Sn) 106, and a non-alloy of a transition metal (M) (element) 108. As an example, the electrode 100 may include a mixture having the silicon 104, the tin 106 and the non-alloy of the transition metal (element) 108. The electrode 100 may be a Si—Sn-M based electrode material.

The electrode 100 may be an electrode for a battery cell or a battery (arrangement). For example, the electrode 100 may be a Si—Sn-M based electrode material for battery cells or batteries (e.g., lithium-ion (Li-ion) battery cells or batteries).

In the context of various embodiments, the term “non-alloy” may mean pure element. Accordingly, a non-alloy of the transition metal 108 may mean pure element of the transition metal 108, or the transition metal 108 is in the form of pure element. In other words, the transition metal 108, as a non-alloy, may not be present as a mixture, combination or compound with another element or material.

In the context of various embodiments, the silicon 104 and/or the tin 106 may be in the form of pure element.

Silicon 104 and tin 106 are known to form alloys with lithium. Due to higher lithium uptake of silicon 104 and tin 106 as compared to carbon, silicon 104 and tin 106 may be good candidates for anode application in a lithium ion battery (LIB). However, when silicon 104 and tin 106 are used alone, they may not provide a long cycle life. The addition of a non-alloy element may be effective in enhancing the cycle life of a silicon and tin-based anode.

In the context of various embodiments, the transition metal 108 may be selected from the group consisting of iron (Fe), manganese (Mn), nickel (Ni), cobalt (Co), vanadium (V), copper (Cu), and zinc (Zn). As a non-limiting example, the electrode 100 may be a Si—Sn—Fe based electrode material, for example, for battery cells or batteries (e.g., lithium-ion (Li-ion) battery cells or batteries).

In various embodiments, at least one of the silicon 104, the tin 106 or the transition metal 108 may be crystalline.

In the context of various embodiments, the electrode 100 may include 10-80 wt % of the silicon 104, 1-50 wt % of the tin 106, and 1-50 wt % of the transition metal 108.

For example, the electrode 100 may include 10-80 wt %, 10-50 wt %, 10-20 wt % or 30-50% of the silicon 104, and/or 1-50 wt %, 1-30 wt %, 1-20 wt %, or 20-50 wt % of the tin 106, and/or 1-50 wt %, 1-30 wt %, 1-20 wt %, or 20-50 wt % of the transition metal 108.

In the context of various embodiments, the electrode 100 may be free of an alloy of the transition metal 108.

In the context of various embodiments, the electrode 100 may be free of an alloy between the transition metal 108 and at least one of the silicon 104 or the tin 106. This means that the electrode 104 may be free of an alloy between the transition metal 108 and the silicon 104 (Si-M), an alloy between the transition metal 108 and the tin 106 (Sn-M), and an alloy of the transition metal 108, the silicon 104 and the tin 106 (Si—Sn-M). In other words, there may be an absence of alloy(s) of Si-M, Sn-M and Si—Sn-M in the electrode 100. The notation of double dash “—” is used herein to represent an alloy.

The anode performance may suffer if element M forms an alloy with silicon 104 and/or tin 106, due to a low reversibility of a reaction between the alloy and lithium. Lithium may replace the element M in the alloy through a mechanism known as displacement reaction, which may not be easily reversible, thus affecting the performance of the alloy.

In the context of various embodiments, the electrode 100 may be free of an alloy between the silicon 104 and the tin 106. This means the absence of an alloy of the silicon 104 and the tin 106 (Si—Sn).

In various embodiments, the electrode 100 may further include a non-alloy of an additional transition metal (M2). This may mean that the electrode 100 may be a Si—Sn-M-M2 based electrode material for battery cells or batteries (e.g., lithium-ion (Li-ion) battery cells or batteries).

In the context of various embodiments, the additional transition metal may be selected from the group consisting of iron (Fe), manganese (Mn), nickel (Ni), cobalt (Co), vanadium (V), copper (Cu), and zinc (Zn).

In the context of various embodiments, the electrode 100 may be free of an alloy of the additional transition metal.

In various embodiments, it should be appreciated that the electrode 100 may further include a non-alloy of a third or more transition metal(s).

In various embodiments, the electrode 100 may further include a carbon-based material (e.g., carbon black). The carbon-based material may be pure carbon element. The carbon-based material may improve the electrical conductivity of the composite electrode 100.

In various embodiments, the electrode 100 may include 10-80 wt % of the carbon-based material, for example, 10-50 wt %, 10-20 wt % or 30-50% of the carbon-based material.

In various embodiments, the electrode 100 may further include a polymeric material. The polymeric material may include polyethylene glycol (PEG) or polyacrylic acid (PAA). The polymeric material may be used as a binder in the composite electrode 100. PEG or PAA may have better binding properties in anodes compared to polyvinylidene difluoride (PVDF). Additionally, PEG or PAA may be water soluble, and may advantageously not require the use of one or more costly and/or environmentally non-benign organic solvents.

Alternatively or additionally, the electrode 100 may further include cellulose based metal salts such as lithium salt of carboxymethyl cellulose (NaCMC) or sodium salt of carboxymethyl cellulose (LiCMC).

In various embodiments, the electrode 100 may further include a carrier 110, wherein the silicon 104, the tin 106, and the non-alloy of the transition metal 108 may be comprised in a coating 102 provided on the carrier 110. In various embodiments, the coating 102 may include one or more other materials as described above, e.g., the non-alloy of the additional transition metal, the carbon-based material, etc.

In various embodiments, the carrier 110 may be electrically conductive. For example, the carrier 110 may include a metal, e.g., a copper (Cu) foil.

In the context of various embodiments, the electrode 100 may be an anode for a battery cell, for example, for lithium-ion (Li-ion) battery cell.

FIG. 1B shows a schematic cross-sectional view of a battery cell 120, according to various embodiments. The battery cell 120 may include a first electrode 100a which may be as described in the context of the electrode 100 of FIG. 1A, a second electrode 122, and an electrolyte 124 electrically coupled to the first electrode 100a and the second electrode 122. The first electrode 100a and the second electrode 122 may be spaced apart from each other. The electrolyte 124 may be in contact with the first electrode 100a and the second electrode 122.

In various embodiments, the electrolyte 124 may be in between the first electrode 100a and the second electrode 122.

In various embodiments, the second electrode 122 may include a lithium-based material. The lithium-based material may include at least one of a lithium foil, lithium-iron-manganese-phosphate (LFMP) or lithium cobalt oxide (LCO; LiCoO2).

In various embodiments, the electrolyte 124 may include a lithium-based electrolyte, for example, lithium hexafluorophosphate (LiPF6).

In various embodiments, the first electrode 100a may be an anode. The second electrode 122 may be a cathode, a counter electrode or a reference electrode.

In various embodiments, the battery cell 120 may include or may be a coin cell or a pouch cell.

FIG. 1C shows a schematic cross-sectional view of a battery arrangement 126, according to various embodiments. The battery arrangement 126 may include a plurality of battery cells 120a, 120b, . . . , 120n. Each battery cell of the plurality of battery cells 120a, 120b, . . . , 120n may be as described in the context of the battery cell 120 of FIG. 1B. The battery arrangement 126 may include two, three, four or any higher number of battery cells 120a, 120b, . . . , 120n. The plurality of battery cells 120a, 120b, . . . , 120n may be electrically coupled or connected to each other, for example, the plurality of battery cells 120a, 120b, . . . , 120n may be connected in series.

As described above, various embodiments may provide a Si—Sn-M based electrode (anode) material for Li-ion battery cells or batteries.

FIG. 1D shows a flow chart 130 illustrating a method of forming an electrode, according to various embodiments.

At 132, a starting material (or starting ingredient or starting composition) including a precursor material of silicon (e.g., silicon powder), a precursor material of tin (e.g., tin powder) and a precursor material of a transition metal (e.g., in powder form) may be provided.

At 134, the starting material may be processed to form an electrode including the silicon, the tin, and a non-alloy of the transition metal.

In various embodiments, at least one of the silicon, the tin or the transition metal in the electrode may be crystalline.

In various embodiments, at 132, 10-80 wt % of the precursor material of the silicon, 1-50 wt % of the precursor material of the tin, and 1-50 wt % of the precursor material of the transition metal may be provided.

In various embodiments, at 134, a mechanical ball milling process may be performed on the starting material. During or in the mechanical ball milling process, a plurality of balls (e.g., stainless steel balls) may be mixed with the starting material.

In various embodiments, the mechanical ball milling process may be performed in an inert atmosphere, for example, having an inert gas, e.g., argon (Ar).

In various embodiments, the mechanical ball milling process may be performed for a duration of between about 0.5 hour and about 20 hours, preferably between about 1 hour and about 10 hours, more preferably between about an hour to about 8 hours, e.g., for about 5 hours.

In various embodiments, the mechanical ball milling process may be performed for a plurality of cycles, each cycle of the plurality of cycles including a milling period and a (separate) pause period. The milling (or running) period may mean a period where the starting material is milled, while the pause period may mean a period where the starting material is at rest. The milling period may be followed by the pause period. In various embodiments, the mechanical ball milling process may be performed between 2 cycles and 20 cycles, preferably about 5 cycles and about 15 cycles, more preferably between about 8 cycles and about 12 cycles e.g., for 10 cycles. As a non-limiting example, each cycle may include a milling (or running) period of about 15 minutes and a pause period of about 15 minutes.

In various embodiments, the mechanical ball milling process may be performed with a ball milling speed of between about 100 rpm (revolutions per minute) and about 1500 rpm (revolutions per minute), preferably between about 200 rpm and about 1000 rpm, more preferably about 300 rpm and about 800 rpm, e.g., about 500 rpm. In various embodiments, a weight ratio of a plurality of balls (e.g., stainless steel balls) used in the mechanical ball milling process to the starting material is between about 0.5 and about 30, preferably between about 1 and about 25, and more preferably between about 5 and about 20.

In various embodiments, after the mechanical ball milling process, at 134, the method may further include forming a mixture including the silicon, the tin, and the non-alloy of the transition metal. For example, in forming the mixture, water may be added.

In various embodiments, the mixture may further include a carbon-based material (e.g., carbon black). 10-80 wt % of the carbon-based material may be comprised in the mixture.

In various embodiments, the mixture may further include a polymeric material. The polymeric material may include polyethylene glycol (PEG) or polyacrylic acid (PAA).

In various embodiments, at 134, the method may further include providing a carrier, and coating the mixture on the carrier to form the electrode. The carrier may be electrically conductive.

In the context of various embodiments, the electrode may be free of an alloy of the transition metal.

In the context of various embodiments, the electrode may be free of an alloy between the transition metal and at least one of the silicon or the tin.

In the context of various embodiments, the electrode 100 may be free of an alloy between the silicon and the tin.

In various embodiments, the starting material may further include a precursor material of an additional transition metal, and, at 134, the starting material may be processed to form the electrode including the silicon, the tin, the non-alloy of the transition metal and a non-alloy of the additional transition metal. This may mean that the mixture formed after the mechanical ball milling process may further include the non-alloy of the additional transition metal.

In the context of various embodiments, the electrode may be free of an alloy of the additional transition metal.

In the context of various embodiments, the transition metal and/or the additional transition metal may be selected from the group consisting of iron (Fe), manganese (Mn), nickel (Ni), cobalt (Co), vanadium (V), copper (Cu), and zinc (Zn).

FIG. 1E shows a flow chart 140 illustrating a method of forming a battery cell, according to various embodiments.

At 141, a first electrode is formed. The first electrode may be formed in accordance with the method as described in the context of the flow chart 130 of FIG. 1D.

At 142, a second electrode is provided.

At 143, an electrolyte is provided electrically coupled to the first electrode and the second electrode. The electrolyte may be provided in between the first electrode and the second electrode.

In various embodiments, the second electrode may include a lithium-based material. The lithium-based material may include at least one of a lithium foil, lithium-iron-manganese-phosphate (LFMP) or lithium cobalt oxide (LCO; LiCoO2).

In various embodiments, the electrolyte may include a lithium-based electrolyte, for example, lithium hexafluorophosphate (LiPF6).

In various embodiments, the first electrode may be an anode. The second electrode may be a cathode, a counter electrode or a reference electrode.

In various embodiments, the battery cell may include or may be a coin cell or a pouch cell.

FIG. 1F shows a diagram 146 illustrating a method of forming a battery arrangement, according to various embodiments.

At 147, a plurality of battery cells are formed. Each battery cell of the plurality of battery cells may be formed in accordance with the method as described in the context of the flow chart 140 of FIG. 1E.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

It should be appreciated that descriptions in the context of any one of the electrode 100, the battery cell 120, and the battery arrangement 126 may correspondingly be applicable in relation to any one of the method of forming an electrode, the method of forming a battery cell, and the method of forming a battery arrangement, and vice versa.

Various embodiments may provide a Si—Sn-M (M=transition metal) based anode material for Li-ion batteries. This material may be synthesized by a simple one-step mechanical ball milling process without any other treatment.

Using Si—Sn—Fe based material as an example, the XRD pattern confirms the presence of crystalline Si, Sn and Fe, respectively. No Si—Fe, Si—Sn, Fe—Sn or other alloys were detected by XRD. The Si—Sn—Fe based material electrode exhibits a high 1st-cycle Coulombic efficiency of >90% and much improved cycling stability comprised between 1500 and 800 mAh/g.

Various embodiments will be described using a Si—Sn—Fe material as a non-limiting example. However, it should be appreciated that the descriptions herein may be applicable for the Si—Sn-M based material of various embodiments, where M may be any one or more transition metal(s).

Synthesis Procedures of Si—Sn—Fe Anode Materials.

As non-limiting examples, the following materials may be used as the starting materials (or precursor materials):
Silicon powder, crystalline, 99.5% (Sigma-Aldrich, trace metals basis, 475238);
Iron powder, 99.999% (Alfa Aesar, metals basis, 00737)*;
Tin powder, 325 mesh, 99.8% (Alfa Aesar, metals basis, 10379);
Carbon black (Super P), ˜100 nm particle size (Alfa Aesar, metals basis, H30253);
Polyethylene glycol (PEG), molecular weight=4000 (Sigma□ Aldrich, 81240).
   * Iron powder may be replaced totally or in part with Mn, Ni, Cu, Co, V and/or other transition metals powders, for example, for making other various anode materials.

The Si—Sn—Fe based anode material is prepared by dry ball milling. The ball milling time is about 5 hours with 10 cycles in total (15 minutes running+15 minutes pause in each cycle). The ball milling speed is approximately 500 rpm. The weight ratio of the stainless (steel) balls and raw materials is ˜17.5. In other words, the weight ratio of the stainless (steel) balls to the raw materials is 17.5:1. The ball jars are assembled in a glove box filled with argon (Ar) (H2O<0.1 ppm and O2<0.1 ppm). The recipes for two samples, Samples A and B, are as shown in Table 1 below:

TABLE 1

| Sample name | Si (g) | Fe (g) | Sn (g) | C (super-p) (g) | PEG (g) |
|---|---|---|---|---|---|
| A | 1 | 0.1 | 0.2 | 0.2 | 0.05 |
| B | 1 | 0 | 0 | 0.1 | 0 |

Sample A is a working example and Sample B is a comparative sample.

Physical Characterization

The as-prepared Si—Sn—Fe materials (Sample A) may be directly used for scanning electron microscopy (SEM) and X-ray diffraction (XRD) measurements. The X-ray diffractograms were obtained by using a monochromatic CuKα radiation with a wavelength (λ) of about 1.5406 Å under V=40 kV and I=40 mA. The XRD data were collected over the 20 range of 20°˜80° at a scanning speed of 1°/min with the step kept at about 0.02°. The determination of the phase was done by using the Match software. The SEM images of the as-grown samples were obtained by using a field-emission SEM (JEOL JSM7600F) operating at about 5 kV.

Coin Cells Preparation

Preparation of the anodes for coin cells: 60 wt % of Si—Sn—Fe anode materials (Sample A) obtained by the ball milling procedure, 10 wt % carbon black (Super P) and 30 wt % polyacrylic acid (PAA) were mixed in a mortar. Then, deionized water was added to prepare a slurry, which was then coated on a piece of copper (Cu) foil. After drying at about 353 K for approximately 45 minutes in a normal oven and at about 323 K overnight in a vacuum oven, the copper foil with active materials was cut into circular pieces with a diameter of about 14 cm.

Assembly of coin cells: The coin-type battery cell was assembled in a glove box, which was filled with argon (Ar) gas and the concentration of moisture and oxygen was less than 1 ppm. Lithium (Li) foils were used as the counter electrode and reference electrode materials. The electrolyte was 1M LiPF6 in ethylene carbonate (EC)/diethyl carbonate (DEC) (1:1 by volume). The cells were tested on a NEWARE multi-channel battery test system.

Pouch Cells Preparation

Preparation of the anodes for pouch cells: The anode slurry was prepared in the same procedures as for coin cells as described above. Then, the slurry was coated onto a copper (Cu) foil. After drying at about 353 K for approximately 45 minutes in a normal oven and at about 323 K overnight in a vacuum oven, the copper foil with active materials was cut into rectangular pieces (9×5 cm or 45×10 cm).

Synthesis of the lithium iron manganese phosphate (LFMP) cathodes for pouch cells: The LFMP was synthesized by a solid-state reaction between MnCO3, Fe(C2O4)*2.2H2O, and LiH2PO4, obtained from Sigma Aldrich. The precursors were mixed thoroughly in stoichiometric ratio with carbon black (acetylene black) in a glovebox filled with argon (Ar) and transferred to ball mill jars with stainless steel balls. A combination of large and small balls were used and the ball to powder (of the precursors) ratio was kept constant at 30. The mixture was ground by high energy ball milling. The samples were pressed into pellets and sintered at about 700° C. for about 10 hours. The sintering process was performed under Ar or Ar—H2 atmosphere. After sintering, the powders were grinded manually using mortar and pestle.

Preparation of the LFMP cathodes for pouch cells: Ball milled LFMP products were mixed with commercial carbon coated LiFePO4 (Clariant). 80 wt % of the mixture, 10 wt % carbon black (Super-P) and 10 wt % polyvinylidene fluoride (PVDF) were mixed. Then, N-methyl-2-pyrrolidone (NMP) was added to prepare a slurry, which was then coated on a piece of aluminum (Al) foil using doctor blade equipment. The aluminum foil with active materials was cut into rectangular pieces (9×5 cm or 45×10 cm).

Preparation of the lithium cobalt oxide (LCO) cathodes for pouch cells: 90 wt % of the LCO (EQ-LIB-LCO), 5 wt % carbon black (Super-P) and 5 wt % polyvinylidene fluoride (PVDF) were mixed. Then, N-methyl-2-pyrrolidone (NMP) was added to prepare a slurry, which was then coated on a piece of aluminum (Al) foil using doctor blade equipment. The aluminum foil with active materials was cut into rectangular pieces (9×5 cm or 45×10 cm).

Assembly of pouch cells: The pouch-type battery cell was assembled in a dry room with a dew point of about −40° C. LFMP electrodes or lithium cobalt oxide (LCO) electrodes were used as the counter electrodes. The electrolyte was 1M LiPF6 in ethylene carbonate (EC)/diethyl carbonate (DEC) (1:1 by volume). The cells were tested on a Biologic multi-channel battery test system.

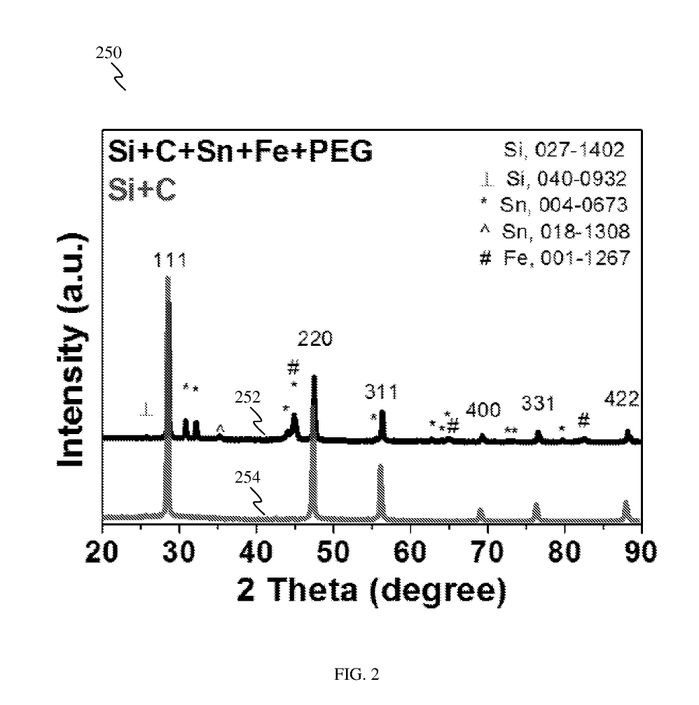

FIG. 2 shows a plot 250 of X-ray diffraction (XRD) patterns for Samples A (result 252) and B (result 254) as described in Table 1. The XRD pattern 252 of Sample A (Si+C+Sn+Fe+PEG) and the XRD pattern 254 for Sample B (Si+C) show that Fe—Si or Fe—Sn alloys are not formed during ball milling. This is different for conventional materials where Fe alloys are reported to form. As shown in FIG. 2, for Sample A, crystalline silicon (Si) (JCPDS no. 027-1402, 040-0932), tin (Sn) (JCPDS no. 004-0673, 018-1308) and iron (Fe) (JCPDS no. 001-1267) may be indexed, respectively. For Sample B, only crystalline Si (JCPDS no. 027-1402, 040-0932) can be indexed.

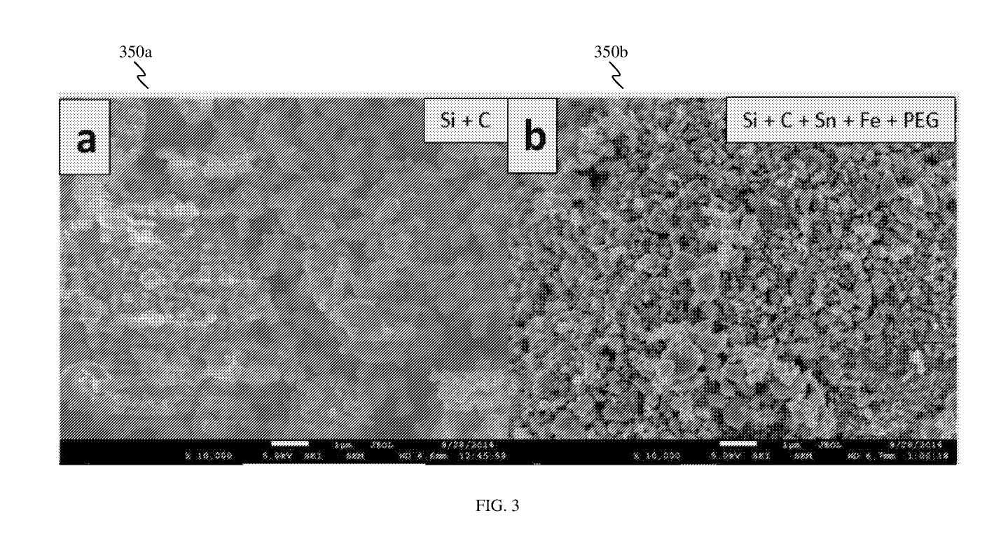

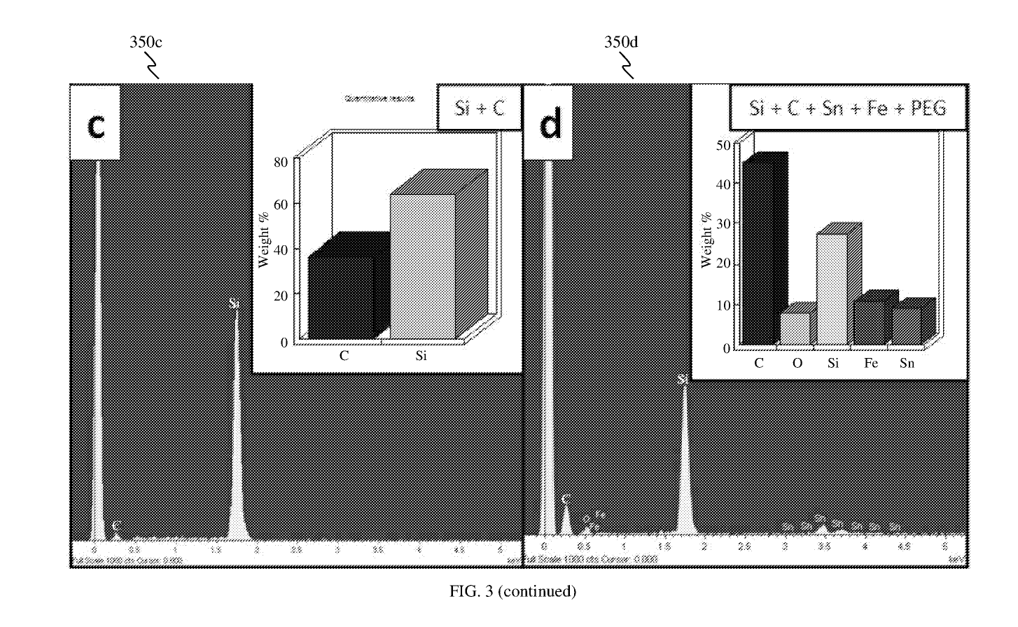

FIGS. 3(a) and 3(b) show scanning electron microscopy (SEM) images of as-prepared Samples A (image 350b) and B (image 350a), indicating that the particle size of the as-prepared samples is around 200-1000 nm. The particles may not be very uniform in size.

FIGS. 3(c) and 3(d) show energy dispersive X-ray (EDX) results for Samples A (results 350d) and B (results 350c). The EDX results 350c show that Si and C are contained in Sample B, and the EDX results 350d show that Si, C, Sn and Fe exist in Sample A.

In various embodiments, it should be appreciated that the contents of the elements in Sample A may be adjustable in the following range as shown in Table 2:

TABLE 2

| ELEMENTS | Si | Fe | Sn | C |
|---|---|---|---|---|
| CONTENTS (%) | 10-80 | 1-50 | 1-50 | 10-80 |

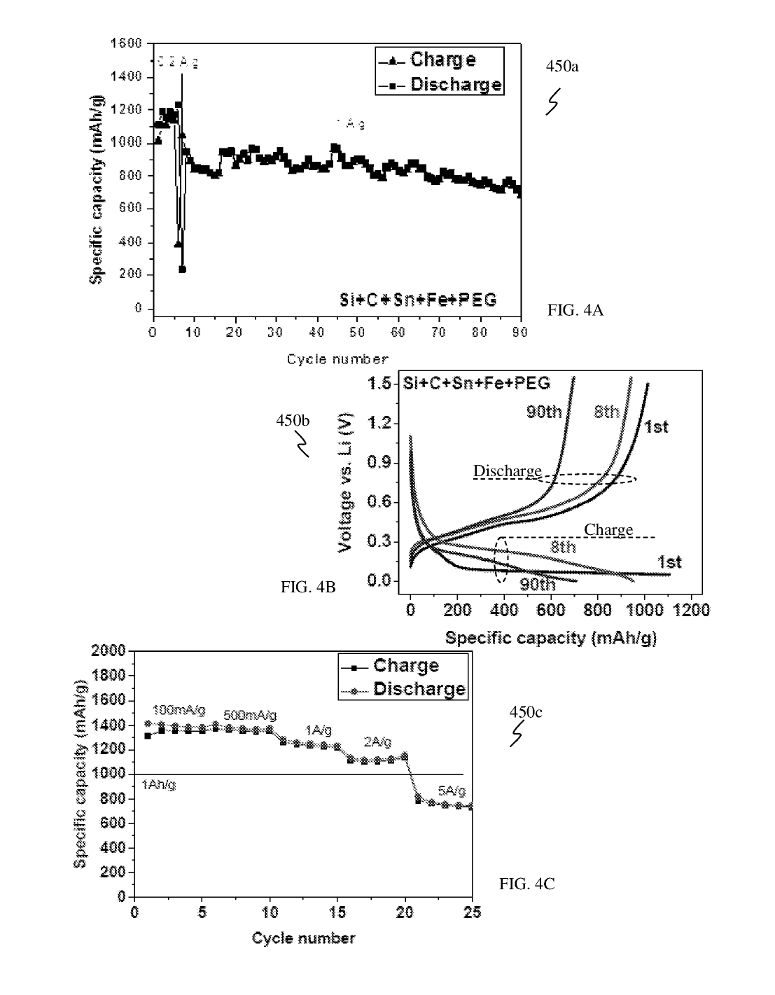

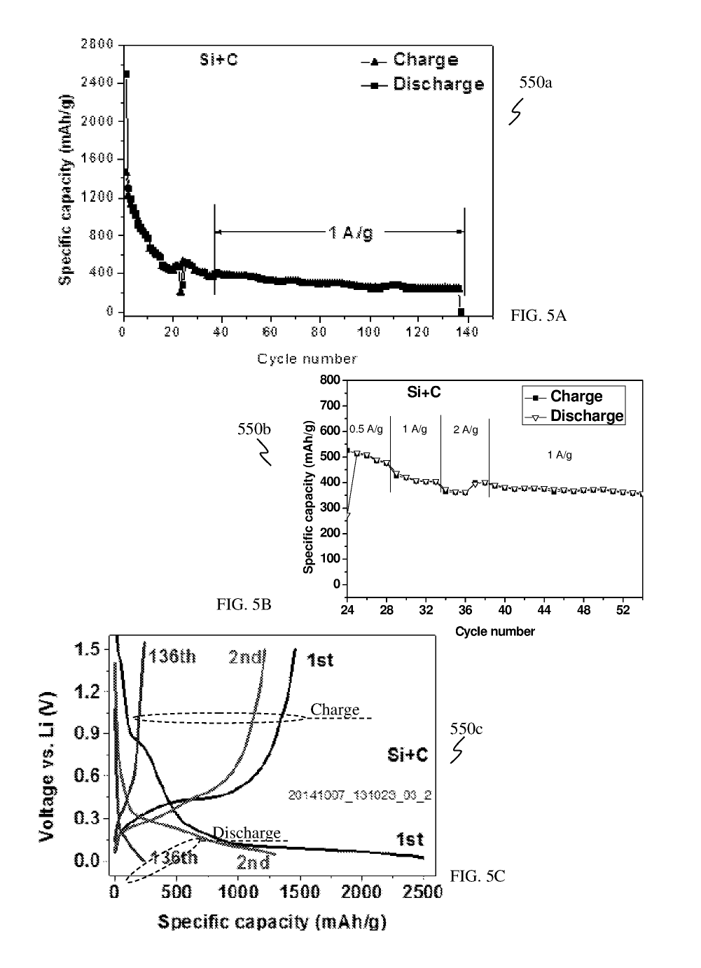

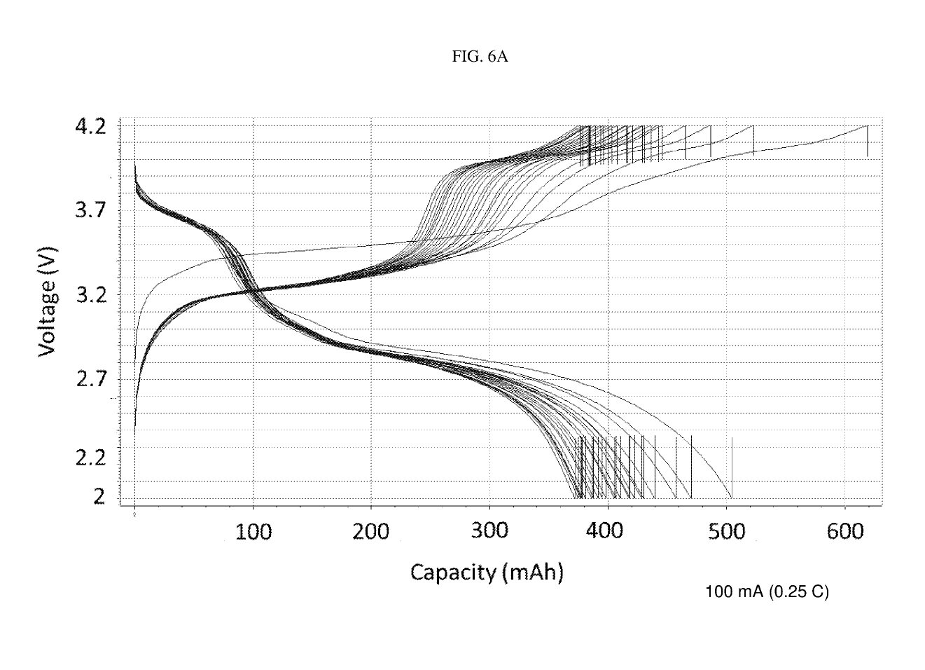

FIGS. 4A to 4C show the lithium (Li) half-cell performance of silicon-iron-tin-carbon (Si—Fe—Sn—C) material (Sample A, see Table 1), according to various embodiments. FIG. 4A shows a plot 450a of the cycling stability of Sample A, FIG. 4B shows a plot 450b of selected voltage profiles corresponding to the results of FIG. 4A, and FIG. 4C shows a plot 450c of the rate responses of Sample A. In FIG. 4B, results are provided for the respective nth cycles for both charge and discharge operations as indicated.

As shown in FIG. 4A, the Sample A electrode exhibits good stability for 90 cycles for both charge and discharge operations. Besides, the Coulombic efficiency in the 1st cycle is up to 92%. The discharge capacity in the 90th cycle is ˜750 mAh/g at 1 A/g (˜1 A/cm2). FIG. 4C shows the rate responses of Sample A, which is able to deliver ˜1100 mAh/g at 2 A/g.

FIGS. 5A to 5C show the battery performance of the comparative silicon-carbon (Si—C) material (Sample B, see Table 1). FIG. 5A shows a plot 550a of the cycling stability of Sample B, FIG. 5B shows a plot 550b of the rate responses of Sample B (cycles 24-54 selected corresponding to the results of FIG. 5A), and FIG. 5C shows a plot 550c of selected voltage profiles corresponding to the results of FIG. 5A. In FIG. 5C, results are provided for the respective nth cycles for both charge and discharge operations as indicated.

In comparison to Sample A (FIGS. 4A to 4C), Sample B depicts poor cycling stability for both charge and discharge operations (FIG. 5A). The discharge capacity decreases from ˜2500 mAh/g in the 1st cycle to ˜400 mAh/g in the 20th cycle. The 1st cycle Coulombic efficiency is only ˜58%.

Pouch cells of various embodiments and their corresponding results will now be described by way of the following non-limiting examples.

Pouch cell double-coated LFMP+Si—Sn—Fe

Details for the pouch cell with double-coated lithium iron manganese phosphate (LFMP) and silicon-tin-iron (Si—Sn—Fe) electrodes are shown in Table 3.

TABLE 3

| Pouch cell | Cathode | | Anode | |
|---|---|---|---|---|
| (454*10 cm, 450 cm²) | (LFMP) | | (Si—Sn—Fe, SSF) | |
| Slurry composition (wt) | LFMP:LFP:PVDF:Super- | | SSF:PAA:Super- | |
| | P = 21:49:15:15 | | P = 7:2:1 | |
| Current collector | 2.36 g, 20 um | | 3.89 g, 10 um | |
| (45*10 cm): mass (g) | | | | |
| & thickness (μm) | | | | |
| Mass of current | 13.87 | g | 4.99 | g |
| collector with coating | | | | |
| Mass of active | 8.057 | g | 0.77 | g |
| materials (g) | | | | |
| Coating thickness (μm) | 500 um filler; | | 300 um filler; | |
| | 310 um-20 um = | | 90 um-10 um = | |
| | 290 um (145) | | 80 um (40) | |
| Density of active | 8.95 | mg/cm² | 0.86 | mg/cm² |
| materials (mg/cm²) | | | | |
| Theoretical specific | 140 | mAh/g | ~1400 | mAh/g |
| capacity (mAh/g) | | | | |
| Theoretical specific | 1.253 | mAh/cm² | 1.204 | mAh/cm² |
| capacity (mAh/cm²) | | | | |
| Theoretical capacity | 1.13 | Ah | 1.08 | Ah |
| of half cell (Ah) | | | | |
| (Ratio = 1:2.5) | | | | |

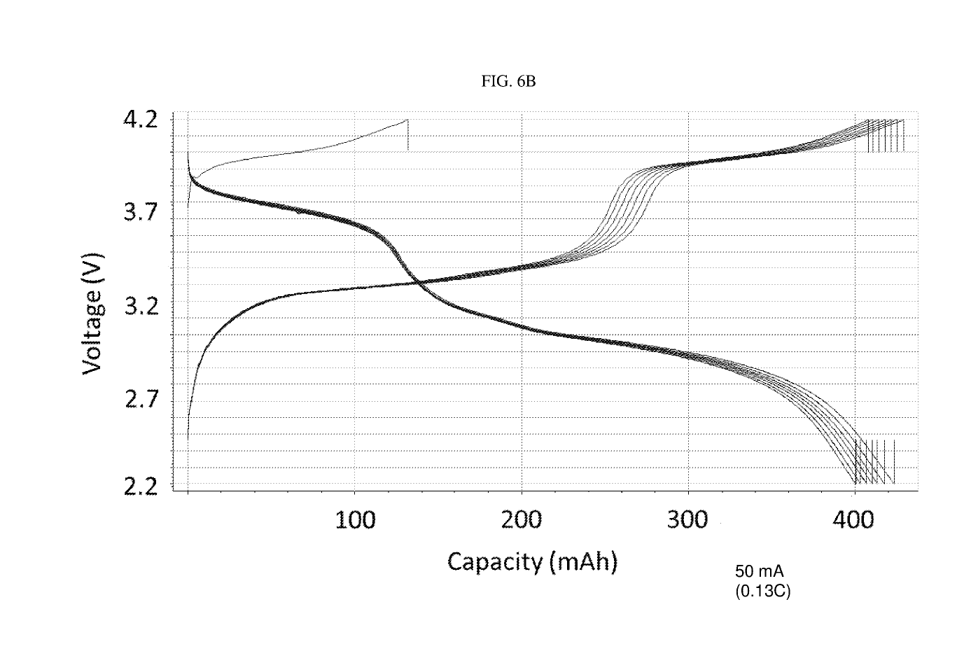

FIGS. 6A and 6B show results of the cycle profiles of the pouch cell with double-coated LFMP (e.g., cathode)+Si-Sn—Fe (e.g., anode). A current of about 100 mA is applied to obtain the profile in FIG. 6A, and a current of about 50 mA is applied to obtain the profile in FIG. 6B. As shown in FIG. 6A, the initial change capacity is about 610 mAh, which decreases to about 370 mAh after 20 cycles. The initial discharge capacity is about 510 mAh, which decreases to about 370 mAh after 20 cycles. On the other hand, as shown in FIG. 6B, the initial charge capacity is about 420 mAh, which decreases to about 405 mAh after 6 cycles. The initial discharge capacity is about 420 mAh, which decreases to about 400 mAh after 6 cycles.

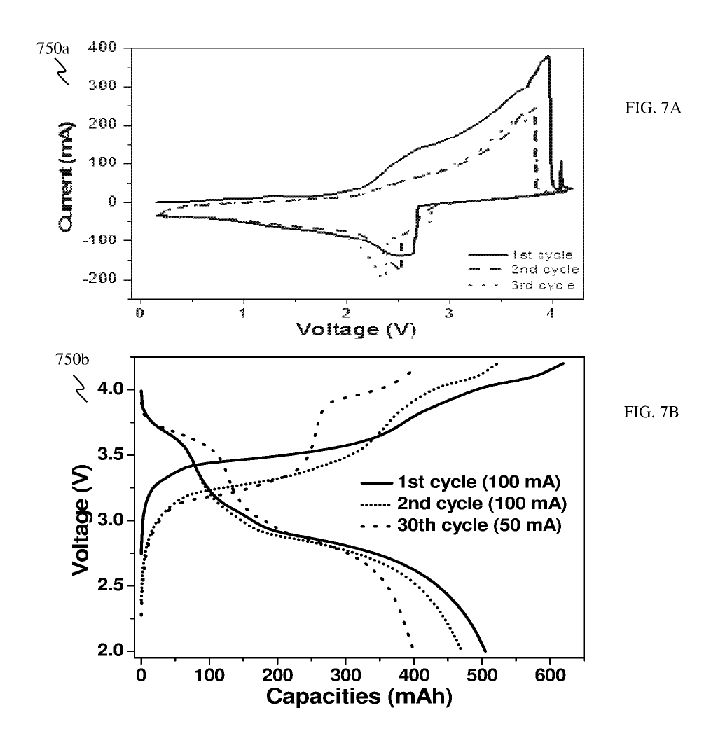

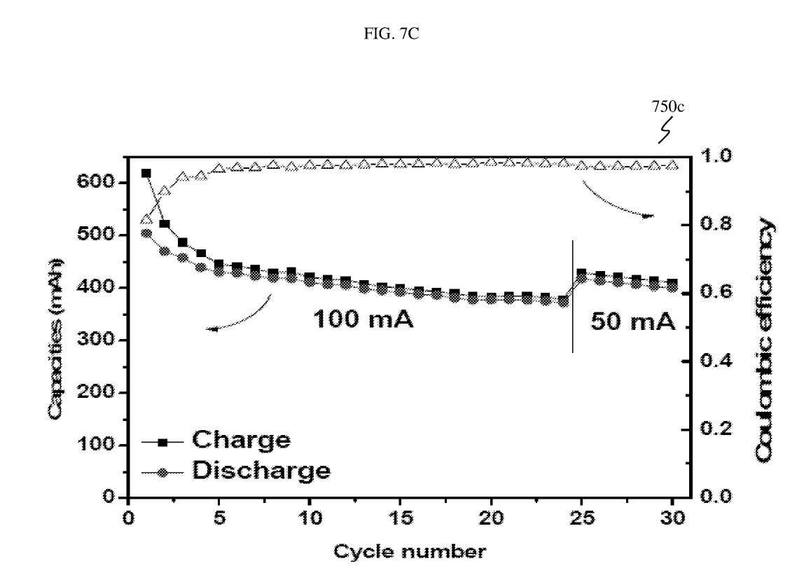

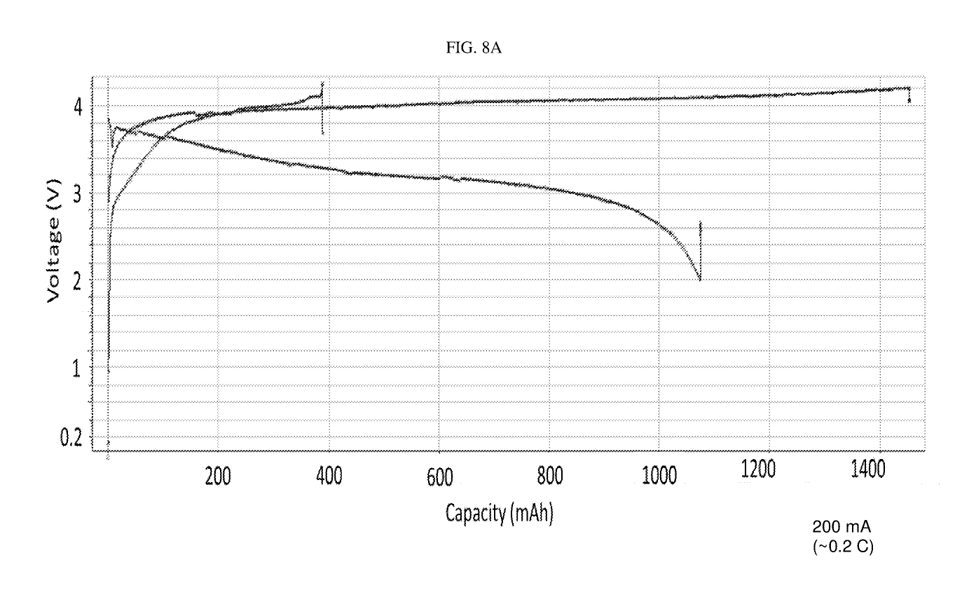

FIGS. 7A to 7C show results for the pouch cell with double-coated lithium iron manganese phosphate (LFMP) and silicon-tin-iron (Si—Sn—Fe) electrodes, according to various embodiments. FIG. 7A shows a plot 750a of current (milliamperes or mA) as a function of voltage (volts or V) illustrating the cyclic voltammetry of the cell, FIG. 7B shows a plot 750b of voltage (volts or V) as a function of capacity (milliamperes-hours or mAh) illustrating the representative discharge and charge voltage profiles at selected cycles (1st, 2nd and 30th cycles), and FIG. 7C shows a plot 750c of capacity/coulombic efficiency as a function of cycle number for 30 cycles illustrating the cycling performance with coulombic efficiency. In FIG. 7A, the cyclic voltammetry curves show that a reduction peak lies at about 2.3 V to about 2.7 V, and an oxidation peak lies at about 3.8 V to about 4 V. A shoulder is also observed for the 1st cycle, but disappears in the following cycles. FIG. 7B and FIG. 7C show that the initial charge and discharge capacities are about 500 mAh and about 600 mAh respectively, with a columbic efficiency (C.E.) of more than 80%. In the 30th cycle, the discharge capacity decreases to about 400 mAh at 50 mA.

Pouch Cell Double-Coated LCO+Si-Sn—Fe

Details for the pouch cell with double-coated lithium cobalt oxide (LCO) and silicon-tin-iron (Si—Sn—Fe) electrodes are shown in Table 4.

TABLE 4

| Pouch cell | Cathode | | Anode | |
|---|---|---|---|---|
| (454*10 cm, 450 cm²) | (LCO) | | (Si—Sn—Fe, SSF) | |
| Slurry composition (wt) | LCO:PVDF:Super- | | SSF:PAA:Super- | |
| | P = 90:5:5 | | P = 7:2:1 | |
| Current collector | 2.36 g, 20 um | | 3.89 g, 10 um | |
| (45*10 cm): mass (g) | | | | |
| & thickness (μm) | | | | |
| Mass of current | 17.86 | g | 5.14 | g |
| collector with coating | | | | |
| Mass of active | 13.95 | g | 0.875 | g |
| materials (g) | | | | |
| Coating thickness (μm) | 300 um filler; | | 400 um filler; | |
| | 270 um-20 um = | | 90 um-10 um = | |
| | 250 um (125) | | 80 um (40) | |
| Density of active | 15.5 | mg/cm² | 0.97 | mg/cm² |
| materials (mg/cm²) | | | | |
| Theoretical specific | 140 | mAh/g | ~1400 | mAh/g |
| capacity (mAh/g) | | | | |
| Theoretical specific | 2.17 | mAh/cm² | 1.358 | mAh/cm² |
| capacity (mAh/cm²) | | | | |
| Theoretical capacity | 1.953 | Ah | 1.225 | Ah |
| of half cell (Ah) | | | | |
| (Ratio = 1:2.5) | | | | |

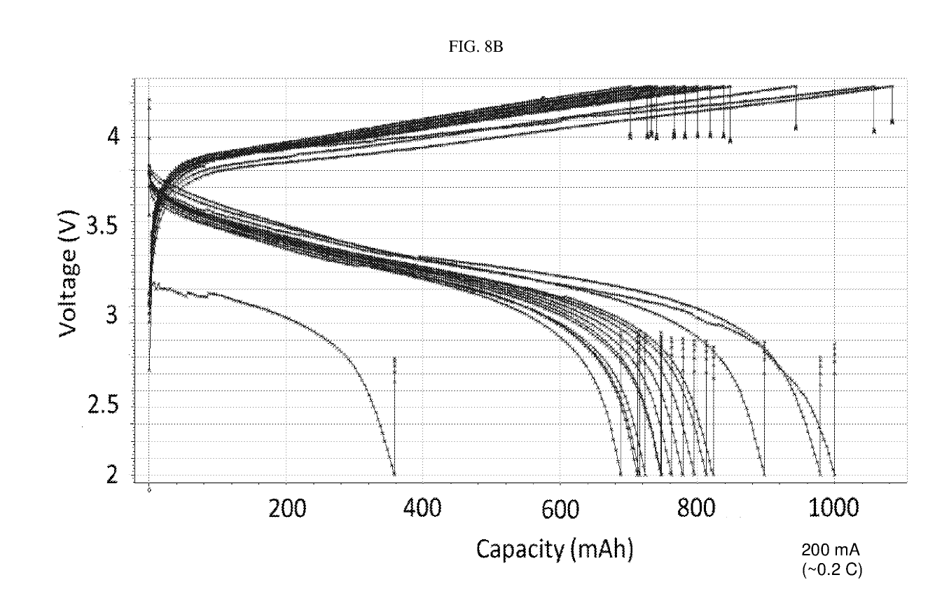

FIGS. 8A and 8B show results of the cycle profiles of the pouch cell with double-coated LCO (e.g., cathode)+Si-Sn—Fe (e.g., anode). The applied current to obtain the cyclic profiles is 200 mA. FIG. 8A shows the voltage profiles in the initial several cycles. As shown in FIG. 8A and FIG. 8B, the discharge capacities range from about 350 mAh to about 1100 mAh, and the charge capacities range from about 350 mAh to about 1450 mAh for the 15 cycles.

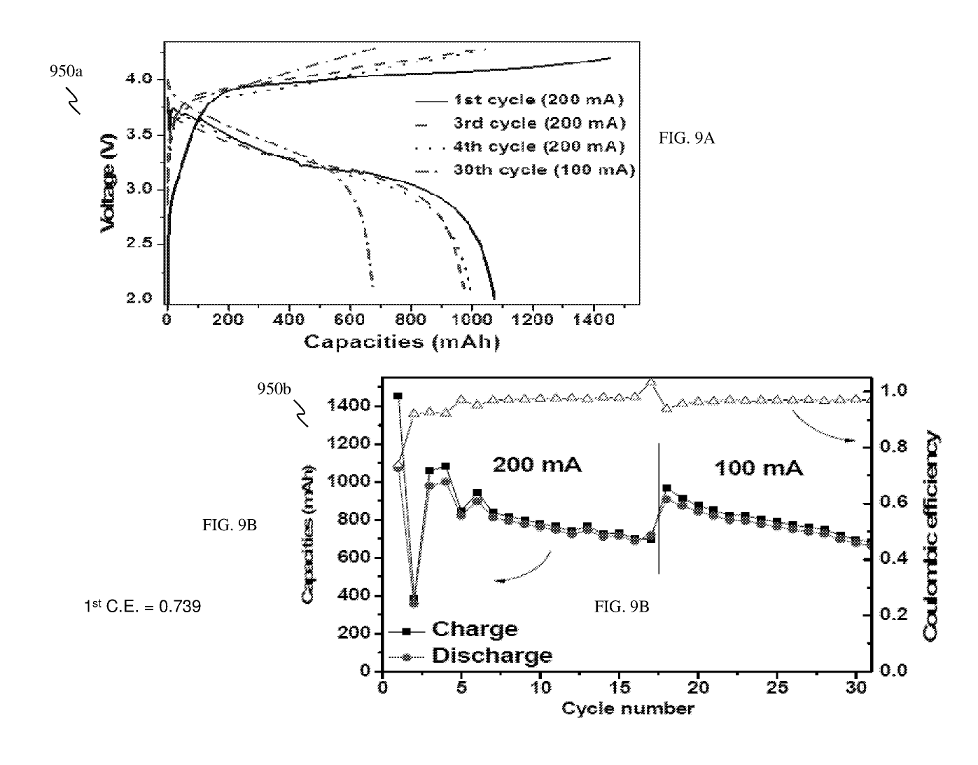

FIGS. 9A and 9B show results for the pouch cell with double-coated lithium cobalt oxide (LCO) and silicon-tin-iron (Si—Sn—Fe) electrodes, according to various embodiments. FIG. 9A shows a plot 950a of voltage (volts or V) as a function of capacity (milliamperes-hours or mAh) illustrating the representative discharge and charge voltage profiles at selected cycles (1st, 2nd and 4th cycles at 200 mA, 30th cycle at 100 mA), and FIG. 9B shows a plot 950b of capacity/coulombic efficiency as a function of cycle number for 30 cycles illustrating the cycling performance with coulombic efficiency. As shown in FIG. 9A, the initial discharge and charge capacities are about 1100 mAh and about 1300 mAh respectively, with a Coulombic efficiency (C.E.) of about 73.9%. The discharge capacity decreases to about 680 mAh after 30 cycles. As shown in FIG. 9B, the discharge capacity is about 700 mAh in the 17th cycle. Then the current is lowered to 100 mA. Both the discharge and charge capacities increase to about 900 mAh at first and decreases to about 680 mAh in the 30th cycle.

As described above, one or more electrode or anode materials based on silicon (Si), tin (Sn), M (M=at least one of iron (Fe), manganese (Mn), nickel (Ni), cobalt (Co), vanadium (V), copper (Cu), or zinc (Zn), etc.) and carbon (C) elements have been successfully synthesized. The synthesis process includes or consists of 1-step ball milling in argon, making it more cost effective than for similar conventional materials.

The materials of various embodiments are characterized by the fact that they do not contain alloys based on Si, Sn and M, e.g., absence of alloys of Si—Sn, Si-M, Sn-M or Si—Sn-M.

The composition range of each component of the materials of various embodiments may be: Si: 10-50 wt %, M: 1-50 wt %, Sn: 1-50 wt %, and C: 10-80 wt %.

In terms of performance, as a non-limiting example, the Si—Sn—Fe—C material shows: 1) a high first cycle efficiency (>90%) and a 2) a high cycle capacity (1200 mAh/g to 800 mAh/g, >2.4-3.5× current graphite anode material).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An electrode comprising:
silicon;
tin; and
a non-alloy of a transition metal.

2. The electrode as claimed in claim 1, wherein the transition metal is selected from the group consisting of iron, manganese, nickel, cobalt, vanadium, copper, zinc, and combinations thereof.

3. The electrode as claimed in claim 1, wherein at least one of the silicon, the tin or the transition metal is crystalline.

4. The electrode as claimed in claim 1, wherein the electrode comprises:
10-80 wt % of the silicon;
1-50 wt % of the tin; and
1-50 wt % of the transition metal.

5. The electrode as claimed in claim 1, wherein the electrode is free of an alloy of the transition metal.

6-14. (canceled)

15. The electrode as claimed in claim 1, further comprising:
a carrier,
a coating provided on the carrier; wherein the silicon, the tin, and the non-alloy of the transition metal are comprised in the coating.

16. The electrode as claimed in claim 15, wherein the carrier is electrically conductive.

17. A battery cell comprising:
a first electrode as claimed in claim 1;
a second electrode; and
an electrolyte electrically coupled to the first electrode and the second electrode.

18-24. (canceled)

25. A method of forming an electrode, the method comprising:
providing a starting material comprising a precursor material of silicon, a precursor material of tin and a precursor material of a transition metal; and
processing the starting material to form an electrode comprising the silicon, the tin, and a non-alloy of the transition metal.

26. The method as claimed in claim 25, wherein the transition metal is selected from the group consisting of iron, manganese, nickel, cobalt, vanadium, copper, zinc, and combinations thereof.

27. The method as claimed in claim 25, wherein at least one of the silicon, the tin or the transition metal is crystalline.

28. The method as claimed in claim 25, wherein providing a starting material comprises providing 10-80 wt % of the precursor material of the silicon, 1-50 wt % of the precursor material of the tin, and 1-50 wt % of the precursor material of the transition metal.

29. The method as claimed in claim 25, wherein processing the starting material comprises performing a mechanical ball milling process on the starting material.

30-34. (canceled)

35. The method as claimed claim 29, wherein, after the mechanical ball milling process, processing the starting material further comprises forming a mixture comprising the silicon, the tin, and the non-alloy of the transition metal.

36. The method as claimed in claim 35, wherein the mixture further comprises a carbon-based material.

37. (canceled)

38. The method as claimed in claim 35, wherein the mixture further comprises a polymeric material.

39. (canceled)

40. The method as claimed in claim 35, wherein processing the starting material further comprises:
providing a carrier; and
coating the carrier with the mixture to form the electrode.

41. (canceled)

42. The method as claimed in claim 25, wherein the electrode is free of an alloy of the transition metal.

43-55. (canceled)

56. The electrode as claimed in claim 1, further comprising a carbon-based material.

57. The electrode as claimed in claim 1, further comprising a polymeric material.
